(19) United States
(12) Patent Application Publication
(10) Pub. No.: US 2021/0342192 A1
(43) Pub. Date: Nov. 4, 2021

(54) Systems And Methods For Optimizing Perceived Software Application Load Delays

(71) Applicant: DELL PRODUCTS L.P., Round Rock, TX (US)

(72) Inventors: Daniel L. Hamlin, Round Rock, TX (US); Danilo O. Tan, Austin, TX (US)

(21) Appl. No.: 16/862,199

(22) Filed: Apr. 29, 2020

(51) Int. Cl. G06F 9/50; G06F 9/48; G06F 9/451

(52) U.S. Cl. CPC G06F 9/5027; G06F 9/4806; G06F 2209/5022; G06F 2209/503; G06F 2209/508; G06F 9/451

(57) ABSTRACT

Systems and methods are provided that may be implemented to pre-launch a given software application in a background state on an information handling system when the given application is predicted to be needed by a user of the information handling system. Using the disclosed systems and methods, the given software application may be pre-loaded into system memory and host execution space in a background state before the system user actually needs to use the given software application, and so that it is loaded and ready for foreground use when it is called for by the system user.

### FIELD OF THE INVENTION

This application relates to operating systems of information handling systems and, more particularly, to executing software applications on information handling systems.

### BACKGROUND

As the value and use of information continues to increase, individuals and businesses seek additional ways to process and store information. One option available to human users is information handling systems. An information handling system generally processes, compiles, stores, and/or communicates information or data for business, personal, or other purposes thereby allowing human users to take advantage of the value of the information. Because technology and information handling needs and requirements vary between different human users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific human user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Users of information handling systems expect instant response from their systems and want their software applications ready and fully available for use when they need to start working. Current application environments compress the application data files onto the disk to optimize storage space. When a given software application is called by the system user, the compressed application is expanded into memory and the application performs initialization routines. These initialization routines can sometimes take a delay of seconds to several minutes, depending on factors such as the system drive media type, available amount of system memory, available CPU bandwidth, etc. This delay can lead to decreased user productivity and a perceived lack of quality and performance from the system. In particular, launching of an application at time of user need negatively impacts productivity more and more as the delay in application launch increases, and this increasing delay contributes to perceived slow PC performance which may result in calls to tech support and associated costs. Launching an application automatically (without user input) may cause confusion and break the user's workflow.

It is known to use an operating system (OS) to cache recently terminated software applications on an information handling system. Specifically, the OS retains a recently terminated application in system memory to improve subsequent load speed of that retained application. However, this only speeds up restart of an application, such as in case of accidental application termination.

### SUMMARY OF THE INVENTION

Disclosed herein are systems and methods that may be implemented to pre-launch a given software application in a background state on an information handling system when the given application is predicted to be needed by a user of the information handling system. Using the disclosed systems and methods, the given software application may be pre-loaded into system memory and host execution space in a background state before the system user actually needs to use the given software application, and so that it is loaded and ready for foreground use when it is called for (i.e., needed) by the system user. This is in contrast to conventional methodology that only caches recently terminated applications in system memory.

Using the disclosed systems and methods, a background software service may in one embodiment be executed on a host programmable integrated circuit (e.g., such as a central processing unit) to predictively perform automatic pre-launching of a given software application (without any system user interaction) to reduce the time required for startup of the given application at the time it is needed by the system user. Advantageously, the given software application may be so pre-launched without exposing the system user to any displayed visual artifacts or other noticeable system behavior from the software application that can cause user distraction.

In one exemplary embodiment, a background software service may be executed on a host programmable integrated circuit to predictively perform automatic pre-launching of a given software application into a background application window maintained in a background virtual desktop environment of the information handling system before the given software application is called for (i.e., needed) by the system user, e.g., such as a within an inactive Microsoft Windows 10 operating system (OS) virtual desktop that is separate from the current active primary desktop running on the system. When the system user is ready to use and calls for launch of the given pre-launched application, the application window for the given application may be moved from the inactive background virtual desktop to the primary or active foreground desktop of the information handling system. Alternatively, when the system user calls for launch of the given application, the virtual desktop may be made active so that the input/output (I/O) foreground for the system user is switched from the current primary desktop to the virtual desktop where the given software application was originally rendered. In either case, this embodiment may be implemented without modifications to a conventional software application (e.g., such as conventional word processing application, conventional spreadsheet application, conventional presentation application, etc.). Rather, an unmodified conventional application may be launched in normal fashion into a background virtual desktop that is not discernible to the user, where it remains loaded and hidden from the system user until called by the system user.

In another exemplary embodiment, a background software service may be executed on a host programmable integrated circuit to predictively cause automatic pre-launching of a given software application before the given software application is called for (i.e., needed) by the user into a minimized background processing state by sending the given application a start reason indication that is recognizable by the given application as a pre-launch command. Such a start reason indication may be sent by the background software service, for example, via a new OS application lifecycle event (e.g., OnPreLaunch), via a command line switch, etc., In any case, the start reason indication may be sent to notify the given application that this is a pre-launch event (rather than a user launch event). In this embodiment, the given application may be configured (e.g., such as by modifying the programming of the code of a conventional software application, or by programming the original code of a new software application) to recognize this received start reason indication as a pre-launch-to-background state command, rather than a launch-to-foreground command.

In this embodiment, the programming of the code of the given application may be further configured to respond to receipt of the pre-launch event by immediately executing time and processing-intensive operations (e.g., such as graphics user interface pre-load, network prefetching, etc.) that are necessary for background execution of the given application, but without performing any other processing activities that would expose the system user to discernible system behavior or actions generated by the given application that might distract the system user from their current work, i.e., such that the pre-launched background application is hidden from the system user. Examples of such user-discernible system behavior or actions that may be suppressed or omitted during application pre-launch include, but are not limited to, production of sounds and/or display of a visual interface such as a splash screen, an application window, one or more task bar elements, etc. Thereafter, when the system user calls for launch of the given pre-launched application at a future time-of-need, most of the time and processing-intensive tasks required for complete launch of the given application from scratch will have already been executed, and startup time to launch the given application into foreground state from its pre-launched background state will therefore be quicker than would otherwise be the case.

In either of the above exemplary embodiments, the background software service may be further programmed to detect when OS resource/s (e.g., system memory, CPU processing, etc.) are being constrained on the information handling system and, if the system user has not yet called for launching of the given pre-launched application, the software service may then choose to automatically terminate the given pre-launched application (again without any system user interaction) so as to release the OS resources that it has been consuming. This allows the constrained system resources to be reclaimed when these system resources are needed for other processes and the user has not yet called and launched the given application into the foreground.

In one respect, disclosed herein is a method, including: operating an information handling system by executing an operating system (OS) and one or more foreground applications on a programmable integrated circuit of the information handling system; collecting input data from operation characteristics of the information handling system; determining if the collected input data indicates an upcoming need for one or more identified given applications that are not currently called for by a system user of the information handling system and that are not executing on a programmable integrated circuit of the information handling system; then pre-launching the one or more identified given applications as background applications executing on the programmable integrated circuit before the identified given applications are called for by the system user only if the collected input data indicates an upcoming need for the one or more identified given applications, the presence of the one or more pre-launched background applications being hidden from the system user and not accepting input from the system user; and then responding to a call from the system user for at least one of the one or more identified given applications by transferring the identified given application to be a foreground application executing on the programmable integrated circuit that is visible to the system user and that accepts input from the system user.

In another respect, disclosed herein is an information handling system, including: at least one programmable integrated circuit; and non-volatile memory coupled to the programmable integrated circuit. The at least one programmable integrated circuit may be programmed to: execute an operating system (OS) and one or more foreground applications, collect input data from operation characteristics of the information handling system, determining if the collected input data indicates an upcoming need for one or more identified given applications that are not currently called for by a system user of the information handling system and that are not executing on the at least one programmable integrated circuit of the information handling system; then pre-launch the one or more identified given applications as background applications executing on the at least one programmable integrated circuit before the identified given applications are called for by the system user only if the collected input data indicates an upcoming need for the one or more identified given applications, the presence of the one or more pre-launched background applications being hidden from the system user and not accepting input from the system user; and then respond to a call from the system user for at least one of the one or more identified given applications by transferring the identified given application to be a foreground application executing on the at least one programmable integrated circuit that is visible to the system user and that accepts input from the system user.

### BRIEF DESCRIPTION OF THE DRAWINGS

FIG. 1 illustrates a block diagram of an information handling system according to one exemplary embodiment of the disclosed systems and methods.

FIG. 2 illustrates a block diagram of an information handling system according to one exemplary embodiment of the disclosed systems and methods.

FIG. 3 illustrates methodology according to one exemplary embodiment of the disclosed systems and methods.

FIG. 4 illustrates methodology according to one exemplary embodiment of the disclosed systems and methods.

### DESCRIPTION OF ILLUSTRATIVE EMBODIMENTS

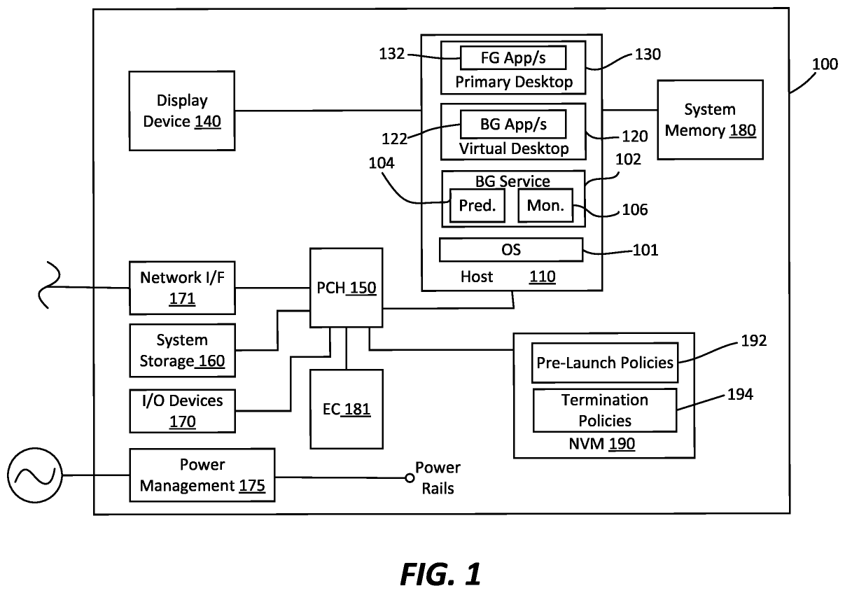

FIG. 1 is a block diagram of an information handling system 100 (e.g., a desktop computer, tower computer, laptop computer, tablet computer, etc.) as it may be configured according to one embodiment of the disclosed systems and methods. In this regard, it should be understood that the configuration of FIG. 1 is exemplary only, and that the disclosed methods may be implemented on other types of information handling systems. It should be further understood that while certain components of an information handling system are shown in FIG. 1 for illustrating embodiments of the disclosed systems and methods, the information handling system is not restricted to including only those components shown in FIG. 1 and described below.

As shown in FIG. 1, information handling system 100 may generally include a host programmable integrated circuit 110 for executing an operating system (OS) 101 (e.g., proprietary OS such as Microsoft Windows 10, open source OS such as Linux OS, etc.) and other code which in this embodiment includes a background service 102, at least one inactive virtual desktop 120 executing in the background with its background software application/s 122, and an active primary desktop 130 executing in the foreground with its foreground software applications 132 (e.g., email application, calendar application, message application, word processing application, Internet browser, PDF viewer, spreadsheet application, etc.). Inactive virtual desktop 120 may be, for example, a Microsoft Windows 10 Virtual Desktop or any other suitable type of inactive desktop, depending on the type of corresponding OS 101. As shown, background service 102 may include prediction logic 104 and monitoring logic 106, e.g., which in on embodiment may be present as individual modules or services.

In FIG. 1, host programmable integrated circuit 110 may be configured to access non-volatile memory 190 (e.g., serial peripheral interface (SPI) Flash memory), e.g., to load and boot part of a system basic input/output system (BIOS). Other non-volatile memory (NVM) devices may be additionally or alternatively present, e.g., including solid state drive/s (SSDs), hard drive/s, etc. Host programmable integrated circuit 110 may include any type of processing device, such as an Intel central processing unit (CPU), an Advanced Micro Devices (AMD) CPU or another programmable integrated circuit. Host programmable integrated circuit 110 may be coupled to volatile system memory 180, which may include, for example, random access memory (RAM), dynamic RAM (DRAM), synchronous DRAM (SDRAM).

In the illustrated embodiment, host programmable integrated circuit 110 may be coupled to an external or internal (integrated) display device 140 (e.g., LCD or LED display or other suitable display device) depending on the particular configuration of information handling system 100. In such an embodiment, integrated graphics capability may be implemented by host programmable integrated circuit 110 to provide visual images (e.g., a graphical user interface, static images and/or video content) to a system user. However, in other embodiments, a separate programmable integrated circuit (e.g., such as graphics processor unit “GPU”) may be coupled between host programmable integrated circuit 110 and display device 140 to provide graphics capability for information handling system 100.

PCH 150 controls certain data paths and manages information flow between components of the information handling system 100. As such, PCH 150 may include one or more integrated controllers or interfaces for controlling the data paths connecting PCH 150 with host programmable integrated circuit 110, system storage 160, input/output (I/O) devices 170 (e.g., keyboard, mouse, trackpad, etc.) forming at least a part of a user interface for the information handling system, network interface (I/F) device 171, embedded controller (EC) 181, and NVM 190, e.g., where BIOS firmware image and settings may be stored together with other components including ACPI firmware, one or more application pre-launch policies 192 and one or more application termination policies 194. It will be understood that application pre-launch policies 192 and application termination policies 194 may be alternatively stored on any other non-volatile storage of system 100, e.g., such as system storage 160.

In one embodiment, PCH 150 may include a Serial Peripheral Interface (SPI) controller and an Enhanced Serial Peripheral Interface (eSPI) controller. In some embodiments, PCH 150 may include one or more additional integrated controllers or interfaces such as, but not limited to, a Peripheral Controller Interconnect (PCI) controller, a PCI-Express (PCIe) controller, a low pin count (LPC) controller, a Small Computer Serial Interface (SCSI), an Industry Standard Architecture (ISA) interface, an Inter-Integrated Circuit (I²C) interface, a Universal Serial Bus (USB) interface and a Thunderbolt™ interface.

As shown in FIG. 1, external and/or internal (integrated) I/O devices 170 (e.g., a keyboard, mouse, touchpad, touchscreen, etc.) may be coupled to PCH 150 of system 100 to enable the system end user to input data and interact with information handling system 100, and to interact with application programs or other software/firmware executing thereon. The network I/F device 171 enables wired and/or wireless communication with remote information handling systems via an external network (e.g., the Internet), and in one embodiment may be a network interface controller (NIC) which may communicate with an external network across an intervening local area network (LAN), wireless LAN (WLAN), cellular network, etc.

Also shown present in FIG. 1 is local system storage 160 (e.g., one or more media drives, such as hard disk drives, optical drives, NVRAM, Flash memory, solid state drives (SSDs), or any other suitable form of internal or external storage) that is coupled through PCH 150 to provide non-volatile storage for information handling system 100.

A power source for the information handling system 100 may be provided via an external power source (e.g., mains power) and an internal power supply regulator, and/or by an internal power source, such as a battery. As shown in FIG. 1, power management system 175 may be included within information handling system 100 for moderating the available power from the power source. In one embodiment, power management system 175 may be coupled to provide operating voltages on one or more power rails to one or more components of the information handling system 100, as well as to perform other power-related administrative tasks of the information handling system.

Embedded controller (EC) 181 is coupled to PCH 150 and may be configured to perform functions such as power/thermal system management, etc. EC 181 may also be configured to execute program instructions to boot information handling system 100, load application firmware from NVM 190 into internal memory, launch the application firmware, etc. In one example, EC 181 may include a processing device for executing program instructions to perform the above stated functions. Although not strictly limited to such, processing device of EC 181 may be implemented as a programmable integrated circuit (e.g., a controller, microcontroller, microprocessor, ASIC, etc., or as a programmable logic device “PLD” such as FPGA, complex programmable logic device “CPLD”, etc.).

As further shown in FIG. 1, inactive virtual desktop 120 may at any time include one or more executing background software application/s 122 (e.g., video conferencing application, web conference application, telecommunications (VoIP) application, user-collaboration application, instant messaging application, computer game, etc.) that are not discernible by the system user. In this regard, background application/s 122 do not generate visual images on display device 140 nor accept user input from I/O devices 170 while virtual desktop 120 remains inactive. As described further herein, background software application/s 122 may be pre-launched into inactive virtual desktop 120 under the control of prediction logic 104 of background service 102 according to a pre-launch policy 192 as it is applied to data collected from various foreground applications 132 and/or other processes that are indicative of anticipated system user behavior, such as occurrence of calendar events, content of received emails, content of received messages, etc. Pre-launch policies 192 may also be further defined to include learned user behavior which is gathered during system use by background service 102.

Once pre-launched into inactive virtual desktop 120, a background software application 122 remains in the inactive virtual desktop 120 until it is either moved with user interface (UI) elements to active primary desktop 130 under the control of background service 102 upon launching of the application 122 by the system user (e.g., by mouse clicking on a displayed application icon), or is terminated according to termination policy 194 under the control of monitoring logic 106 of background service 102 to release needed system resources for other purposes. When background application 122 is moved with UI elements from inactive virtual desktop 120 to active primary desktop 130, the application 122 becomes a foreground application that is discernible to the system user on the primary desktop 130 by generating visual images on display device 140 and/or accepting user input from I/O devices 170.

In another embodiment, the state of inactive virtual desktop 120 may be changed from inactive to active under the control of background service 102, at which time the application 122 becomes a foreground application that is discernible to the system user on the now active virtual desktop 120 by generating visual images on display device 140 and/or accepting user input from I/O devices 170. At the same time, the state of primary desktop 130 may be changed (together with its applications 132) from active to inactive under the control of background service 102. In a further embodiment, it is possible to establish multiple different virtual desktops 120 simultaneously executing in the background on host programmable integrated circuit 110 (together with their respective different software application/s 122), and then to alternate between making the state of each of these multiple different virtual desktops 120 active one at a time (together with their respective different software application/s 122) under the control of background service 102 as needed by the system user.

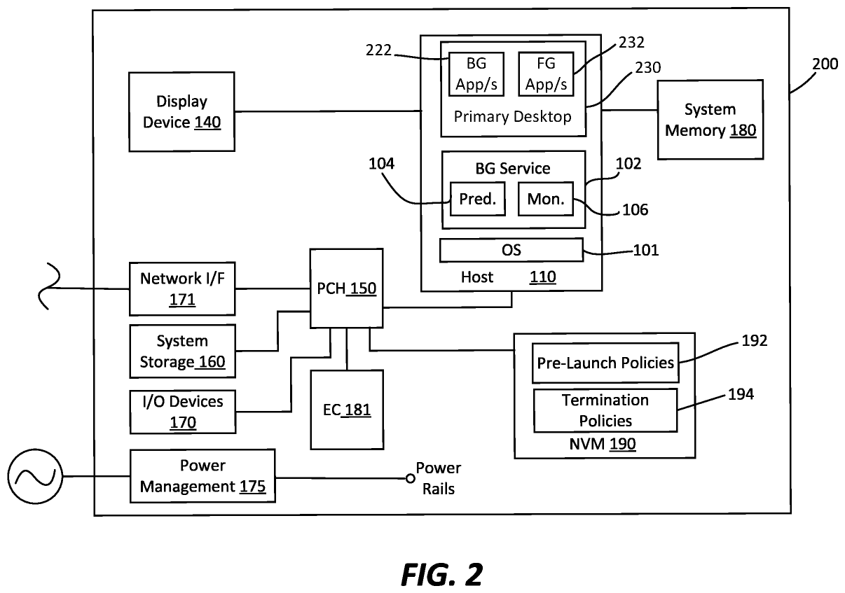

FIG. 2 is a block diagram of an information handling system 200 (e.g., a desktop computer, tower computer, laptop computer, tablet computer, etc.) as it may be configured according to one embodiment of the disclosed systems and methods. As with the embodiment of FIG. 1, it should be understood that the configuration of FIG. 2 is exemplary only, and that the disclosed methods may be implemented on other types of information handling systems. It should be further understood that while certain components of an information handling system are shown in FIG. 2 for illustrating embodiments of the disclosed systems and methods, the information handling system is not restricted to including only those components shown in FIG. 2 and described below.

In the illustrated embodiment of FIG. 2, various hardware and software components having the same element numbers as the embodiment of FIG. 1 may have the same configuration and operation as the similarly-numbered components of the embodiment of FIG. 1. As shown, differences between the embodiment of system 200 of FIG. 2 and the embodiment of system 100 of FIG. 2 are realized in the logic executing on host programmable integrated circuit 110. In this regard, a primary desktop 230 including both background application/s 222 and foreground application/s 232 is shown executing on host programmable integrated circuit 110 of FIG. 2. In this embodiment, background application/s 222 execute in a minimized background processing state (i.e., without user-discernible visuals on display device 140 or other system behavior) in response to a pre-launch command triggered by prediction logic 104 of background service 102. Foreground application/s 232 execute in normal manner, e.g., with visuals displayed on display device 140 and/or other user-discernible system behaviors). As described further herein, when the system user calls for launch of a given pre-launched background application 222, background service 102 commands completion of the full launching of the given application 222 so that it becomes a foreground application 232. As with the embodiment of FIG. 2, a background application 122 remains in the minimized background processing state until it is either fully launched when called by the system user, or is terminated under the control of monitoring logic 106 of background service 102 to release needed system resources for other purposes.

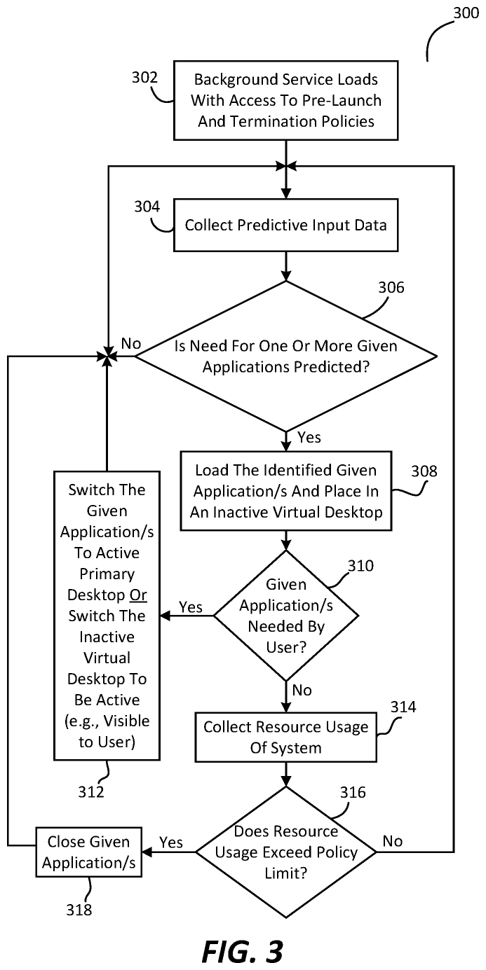

FIG. 3 illustrates one exemplary embodiment of methodology 300 that may be implemented to gather system user behavior data, and automatically pre-launch a given software application 122 into a background application window maintained in an inactive virtual desktop 120 of information handling system 100 of FIG. 1 where it may then be launched into an active state as needed by a system user. As shown, methodology 300 starts in step 302 where background service 102 is loaded during system bootup with access to application pre-launch policies 192 and application termination policies 194.

Next, in step 304, predictive service 104 collects designated predictive input data gathered from operation characteristics of information handling system 100, e.g., such as data collected from various foreground applications 132 and/or other processes that are designated by pre-launch policies 192 as being indicative of system user behavior that is predictive of upcoming user need for one or more given application/s 122. For example, one pre-launch policy 192 may designate that an upcoming teleconference calendar entry is predictive of a system user need for a telecommunications (VoIP) application (e.g., such as Microsoft Skype) and a multi-user collaboration application (e.g., such as Microsoft OneNote), and may also designate the amount of time in advance of the scheduled teleconference (e.g., 15 minutes in advance) that the telecommunications application and multi-user collaboration application are to be pre-launched. In this regard, a pre-defined pre-launch policy 192 may designate times to pre-launch one or more given application/s 122 based on identity of different types of events or other actions (and combinations thereof) gathered from operation characteristics of information handling system 100 as predictive input data.

After collecting the designated predictive input data, predictive service 104 determines in step 306 if the collected predictive input data and pre-launch policies 192 indicate a need for pre-launching of a given application 122. If not, then methodology 300 repeats to step 304. However, if predictive service 104 determines in step 306 that the collected predictive input data does indicate a need for pre-launch of a given application 122 according to a particular pre-launch policy 192, then methodology 300 identifies this given application 122 and proceeds to step 308 described below. As an illustration, according to the example pre-launch policy 192 described above, predictive service 104 will in step 306 identify the telecommunications application and multi-user collaboration application described in the above example when the current calendar date and time of day is within 15 minutes in advance of the time scheduled in the calendar application entry for the upcoming teleconference.

Next, in step 308, background service 102 launches each of the identified given application/s 122 of step 306, loads them into system memory 180, and pushes them into a hidden inactive virtual desktop 120 as background application/s 122 that are hidden from the system user.

Thereafter, background service 102 determines in step 310 if the given background application/s 122 are currently (i.e., immediately) needed by the system user. Current system user need for launching the given background application/s 122 may be indicated to the background service 102, for example, by a system user action that calls the given background application/s 122, e.g., such as a user mouse click on an icon displayed on the user's active primary desktop 130 corresponding to each of the currently needed given background application/s 122.

If the background service 102 determines in step 310 that the given background application/s are currently needed by the system user, then methodology 300 proceeds to step 312 where the background service 102 switches the currently needed background application/s 122 from the inactive virtual desktop 120 to the active primary desktop 130 where they become visible in the foreground to the system user on the display device 140 and accept system user input via I/O devices 170 and/or touchscreen input in those embodiments where display device 140 is a touchscreen. Alternatively, in step 312 the background service 102 may switch the inactive virtual desktop 120 (together with its background application/s 122) to become an active primary desktop 130, in which case the previous given background application/s 122 become visible in the foreground to the system user on the display device 140 and accept system user input via I/O devices 170 and/or touchscreen input in those embodiments where display device 140 is a touchscreen. At this time, methodology 300 may return and repeat beginning at step 304 as shown in FIG. 3.

However, if the background service 102 determines in step 310 that the given background application/s 122 are not currently needed by the system user, then methodology 300 proceeds to step 314 where the monitor service 106 of the background service 102 collects current resource usage data (e.g., utilization percentage of the host programmable integrated circuit 110, memory utilization percentage of system memory 180, etc.), e.g., from Microsoft Windows OS resource monitor utility or other corresponding OS resource monitor utility.

Next, in step 316, monitor service 106 determines if current usage of one or more of the system resources (e.g., host processing utilization, system memory utilization, etc.) exceeds one or more corresponding predefined resource utilization threshold values designated in application termination policies 194, such that ability does not exist for background application/s 122 to remain in system memory 180. In one embodiment, the type and value of one or more resource utilization threshold values may be predefined or provisioned (e.g., by a manufacturer or vendor of the information handling system 100, system user, etc.), and stored in NVM 190 or other suitable non-volatile storage. As an example, predefined resource utilization threshold values stored in application termination policies 194 may be 80% host (e.g., CPU) utilization and/or 80% system memory utilization, although it will be understood that any other greater or lesser resource utilization threshold values may be predefined as desired or needed for a given system instantiation.

If monitor service 106 determines in step 316 that current usage of one or more of the system resources exceeds one or more of the corresponding resource utilization threshold values designated in application termination policies 194, then background service 102 terminates and unloads the given background application/s 122 that are executing in the inactive virtual desktop 120, and methodology 300 returns and repeats beginning at step 304 as shown in FIG. 3. In one embodiment where multiple given background application/s 122 have been pre-launched and queued in inactive virtual desktop 120 according to different pre-launch policies 192, monitor service 106 may identify and select which portion of the given background application/s 122 currently executing in inactive virtual desktop 120 are to be terminated so as to reduce the current usage of the one or more system resources until it no longer exceeds the one or more corresponding predefined resource utilization threshold values, while leaving the remaining portion of the queued multiple given background application/s 122 loaded and executing in the inactive virtual desktop 120. In one embodiment, this selection of which of the multiple given background application/s 122 to terminate may be made by monitor service 106 based on one or more pre-defined policy criteria, such as application priority (e.g., terminating executing pre-launched background applications according to a predefined application priority policy that ranks specific applications to be terminated before other specific applications with regard to the currently executing multiple pre-launched background applications), first in-first out (FIFO) termination of the currently executing pre-launched background applications, terminating currently executing background applications first that exhibit the largest resource usage characteristics, etc.

If monitor service 106 determines in step 316 that current usage of the system resources does not exceed any of the corresponding resource utilization threshold values designated in application termination policies 194, then methodology returns and repeats beginning at step 304 as shown. In this regard, it will be understood that additional different given background application/s 122 may be subsequently identified and pre-launched into inactive virtual desktop 120 according to different pre-launch policies 192. One example of such a different pre-launch policy 192 may be to pre-launch a graphics or photo-editing application (e.g., such as Adobe Photoshop) into inactive virtual desktop 120 when background service 102 detects that the system user has loaded a digital photograph into an image viewing application (e.g., such as Microsoft Windows 10 Photos app). Such an additional pre-launch policy 192 may be predefined (e.g., by system manufacturer or vendor, system user, etc.) in NVM 190 as previously described, or may alternatively be created later by background service 102 based on learned usage behavior over a period of time or number of system boots, e.g., such as when background service 102 detects that the system user loads the graphics or photo-editing application greater than 50% of the time after loading the image-viewing application to view a photograph. In any case, the subsequently-added given background application/s 122 may be queued together in step 308 with the existing executing given background application/s 122 already in inactive virtual desktop 120.

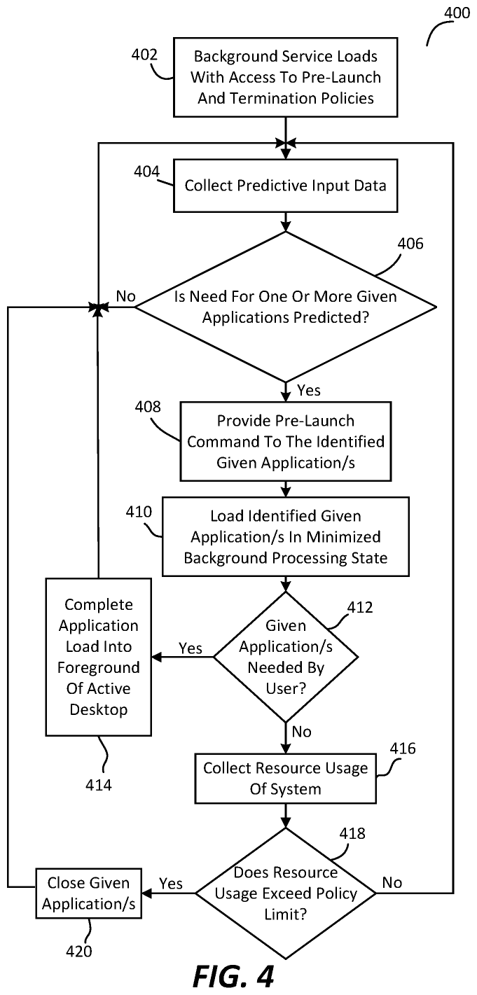

FIG. 4 illustrates another exemplary embodiment of a methodology 400 that may be implemented to gather system user behavior data, and automatically pre-launch a given software application 122 in a minimized background processing state in an active primary desktop 230 of information handling system 200 of FIG. 2 where it may then be launched into foreground processing state as needed by a system user. As shown, methodology 400 starts in step 402 where background service 102 is loaded during system bootup with access to application pre-launch policies 192 and application termination policies 194.

Next, in step 404, predictive service 104 collects designated predictive input data gathered from operation characteristics of information handling system 100 in the same manner as described for step 304 of FIG. 3.

After collecting the designated predictive input data, predictive service 104 determines in step 406 if the collected predictive input data and pre-launch policies 192 indicate a need for pre-launching of a given application 222. If not, then methodology 400 repeats to step 404. However, if predictive service 104 determines in step 406 that the collected predictive input data does indicate a need for pre-launch of a given application 222 according to a particular pre-launch policy 192, then methodology 400 identifies this given application 222 in the same manner as described for step 306 of FIG. 3 and proceeds to step 408 described below.

Next, in step 408, background service 102 sends each of the identified given applications 222 a start reason indication that is recognizable by the identified given application 222 as a pre-launch command. Such as start reason indication may be sent, for example, via a new OS application lifecycle event (e.g., OnPreLaunch), via a command line switch, etc.

In step 410, each identified given application 222 receives and is programmed to recognize its respective received start reason indication as a pre-launch-to-background state command, rather than a launch-to-foreground command. At this time in step 410, each identified given application 222 responds to receipt of the pre-launch command by partially loading in a minimized background processing state hidden from the system user in which time and processing-intensive operations/functions necessary for background execution of the given application (e.g., such as data load, network acquisition, etc.) are loaded and executed, while limiting and delaying all screen write and I/O functions (e.g., such as display of graphics or other visuals on display device 140, accepting user input via I/O devices 170 and/or touchscreen, etc.) and any other functions that would expose the system user to discernible system behavior or actions generated by the given application/s 222 that might distract the system user from their current work.

Thereafter, background service 102 determines in step 412 if the given background application/s 222 are currently (i.e., immediately) needed by the system user. Similar to step 310 of FIG. 3, current system user need for launching the given background application/s 222 may be indicated to the background service 102, e.g., by a system user action such as a user mouse click on an icon displayed on the user's active primary desktop 130 corresponding to each of the currently needed one or more given background application/s 222.

If the background service 102 determines in step 412 that the given background application/s 222 are currently needed by the system user, then methodology 400 proceeds to step 414 where the background service notifies the given application/s 222 to complete load of the given application/s 222 so that they become foreground applications 232 executing in a full foreground processing state on the active desktop 230. At this time background service 102 also releases all user interface (UI) related processes and functions to the given application/s 222 so as to allow them to be visually seen as foreground application/s 232 in the foreground on display device 140 together with any other user-discernible functions (e.g., such as production of sounds, etc.) and to accept user input via I/O devices 170 and/or touchscreen in those embodiments where display device 140 is a touchscreen. At this time, methodology 400 may return and repeat beginning at step 404 as shown in FIG. 4.

However, if the background service 102 determines in step 412 that the given background application/s 222 are not currently needed by the system user, then methodology 400 proceeds to step 416 where the monitor service 106 of the background service 102 collects current resource usage data in the same manner as described for step 314 of FIG. 3.

Next, in step 418, monitor service 106 determines if current usage of one or more of the system resources exceeds one or more of the corresponding resource utilization threshold values designated in application termination policies 194 in the same manner as described for step 316 of FIG. 3. If monitor service 106 determines in step 418 that current usage of one or more of the system resources exceeds one or more of the corresponding resource utilization threshold values designated in application termination policies 194, then in step 420 background service 102 terminates and unloads the given background application/s 222 that are executing in the active desktop 230, and methodology 400 returns and repeats beginning at step 404 as shown in FIG. 4. In one embodiment where multiple given background application/s 222 have been pre-launched and queued in a minimized processing state on active desktop 230 according to different pre-launch policies 192, monitor service 106 may identify and select which portion of the given background application/s 222 currently executing minimized processing state on active desktop 230 are to be terminated while leaving the remaining portion of the queued multiple given background application/s 222 loaded and executing in the active desktop 230 in the same manner as described for step 318 of FIG. 3.

If monitor service 106 determines in step 418 that current usage of the system resources does not exceed any of the corresponding resource utilization threshold values designated in application termination policies 194, then methodology returns and repeats beginning at step 404 as shown.

It will understood that the particular combination of steps of FIGS. 3 and 4 are exemplary only, and that other combinations of additional and/or alternative steps may be employed that are suitable for pre-launching a given software application on an information handling system in a background state when the given application is predicted to be needed by a user of the information handling system so that it is loaded and ready for use when it is called for by the system user.

It will also be understood that one or more of the tasks, functions, or methodologies described herein (e.g., including those described herein for components 110, 140, 171, 175, 181, etc.) may be implemented by circuitry and/or by a computer program of instructions (e.g., computer readable code such as firmware code or software code) embodied in a non-transitory tangible computer readable medium (e.g., optical disk, magnetic disk, non-volatile memory device, etc.), in which the computer program includes instructions that are configured when executed on a processing device in the form of a programmable integrated circuit (e.g., processor such as CPU, controller, microcontroller, microprocessor, ASIC, etc. or programmable logic device “PLD” such as FPGA, complex programmable logic device “CPLD”, etc.) to perform one or more steps of the methodologies disclosed herein. In one embodiment, a group of such processing devices may be selected from the group consisting of CPU, controller, microcontroller, microprocessor, FPGA, CPLD and ASIC. The computer program of instructions may include an ordered listing of executable instructions for implementing logical functions in an processing system or component thereof. The executable instructions may include a plurality of code segments operable to instruct components of an processing system to perform the methodologies disclosed herein.

It will also be understood that one or more steps of the present methodologies may be employed in one or more code segments of the computer program. For example, a code segment executed by the information handling system may include one or more steps of the disclosed methodologies. It will be understood that a processing device may be configured to execute or otherwise be programmed with software, firmware, logic, and/or other program instructions stored in one or more non-transitory tangible computer-readable mediums (e.g., data storage devices, flash memories, random update memories, read only memories, programmable memory devices, reprogrammable storage devices, hard drives, floppy disks, DVDs, CD-ROMs, and/or any other tangible data storage mediums) to perform the operations, tasks, functions, or actions described herein for the disclosed embodiments.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touch screen and/or a video display. The information handling system may also include one or more buses operable to transmit communications between the various hardware components.

While the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed systems and methods may be utilized in various combinations and/or independently. Thus the invention is not limited to only those combinations shown herein, but rather may include other combinations.

What is claimed is:

1. A method, comprising:
operating an information handling system by executing an operating system (OS) and one or more foreground applications on a programmable integrated circuit of the information handling system;
collecting input data from operation characteristics of the information handling system;
determining if the collected input data indicates an upcoming need for one or more identified given applications that are not currently called for by a system user of the information handling system and that are not executing on a programmable integrated circuit of the information handling system;
then pre-launching the one or more identified given applications as background applications executing on the programmable integrated circuit before the identified given applications are called for by the system user only if the collected input data indicates an upcoming need for the one or more identified given applications, the presence of the one or more pre-launched background applications being hidden from the system user and not accepting input from the system user; and
then responding to a call from the system user for at least one of the one or more identified given applications by transferring the identified given application to be a foreground application executing on the programmable integrated circuit that is visible to the system user and that accepts input from the system user.

2. The method of claim 1, further comprising:
collecting current resource usage data from operation characteristics of the information handling system while the one or more identified given applications are executing as pre-launched background applications on the programmable integrated circuit;
determining if the collected current resource usage data exceeds one or more predefined corresponding resource utilization threshold values; and
then terminating execution of at least one of the executing pre-launched background applications only if the collected current resource usage data exceeds the one or more predefined corresponding resource utilization threshold values to reduce the current usage of the one or more system resources so that the current usage of the one or more system resources no longer exceeds the one or more corresponding predefined resource utilization threshold values.

3. The method of claim 1, further comprising:
pre-launching multiple identified given applications as multiple respective pre-launched background applications executing on the programmable integrated circuit before the multiple identified given applications are called for by the system user only if the collected input data indicates an upcoming need for the multiple identified given applications, the presence of the multiple pre-launched background applications being hidden from the system user and not accepting input from the system user;
collecting current resource usage data from operation characteristics of the information handling system while the multiple identified given applications are executing as multiple respective pre-launched background applications on the programmable integrated circuit;
determining if the collected current resource usage data exceeds one or more predefined corresponding resource utilization threshold values; and
then selecting and terminating execution of only a first portion of the executing multiple pre-launched background applications only if the collected current resource usage data exceeds the one or more predefined corresponding resource utilization threshold values to reduce the current usage of the one or more system resources so that the current usage of the one or more system resources no longer exceeds the one or more corresponding predefined resource utilization threshold values while not terminating a remaining second portion of the executing multiple pre-launched background applications.

4. The method of claim 3, where the selecting and terminating execution of only a first portion of the executing multiple pre-launched background applications comprises selecting and terminating the first portion of the executing multiple pre-launched background applications according to a defined termination policy that includes at least one of terminating an executing pre-launched background application having a lower defined priority ranking before terminating one or more other executing pre-launched background application/s having a higher defined priority ranking, terminating an executing pre-launched background application that was pre-launched before one or more other executing pre-launched background application/s that were pre-launched later according to a first in-first out (FIFO) policy, or terminating an executing pre-launched background application first that exhibits the largest resource usage characteristics relative to other executing pre-launched background application/s.

5. The method of claim 1, where the collecting input data from operation characteristics of the information handling system comprises collecting data from the executing foreground applications and/or other processes executing on the programmable integrated circuit that are designated by a defined pre-launch policy as being indicative of system user behavior that is predictive of upcoming user need for one or more given application/s; and where the determining if the collected input data indicates an upcoming need for one or more identified given applications comprises applying pre-defined criteria of the defined pre-launch policy to the collected input data to determine if the collected data from the executing foreground applications and/or other processes executing on the programmable integrated circuit indicates an upcoming need for one or more identified given applications.

6. The method of claim 1, where the pre-launching of the one or more identified given applications as background applications executing on the programmable integrated circuit comprises determining a time to pre-launch the one or more identified given applications based on a defined pre-launch policy.

7. The method of claim 1, further comprising simultaneously executing an active primary desktop and an inactive virtual desktop on the programmable integrated circuit; where the pre-launching of the one or more identified given applications comprises pre-launching the one or more software applications as background applications within the inactive virtual desktop that are hidden from the system user and that do not accept input from the system user; and where the responding to the call from the system user for the at least one identified given application comprises transferring the at least one given application from the inactive virtual desktop to be a foreground application within the active primary desktop where it is visible to the system user and accepts input from the system user.

8. The method of claim 1, further comprising simultaneously executing a first active primary desktop and an inactive virtual desktop on the programmable integrated circuit; where the pre-launching of the one or more identified given applications comprises pre-launching the one or more software applications as background applications within the inactive virtual desktop that are hidden from the system user and that do not accept input from the system user; and where the responding to the call from the system user for the at least one identified given application comprises transferring the inactive virtual desktop to be a second active primary desktop that includes the at least one identified given application executing as a foreground application that is visible to the system user and that accepts input from the system user within the second active primary desktop.

9. The method of claim 1, where the pre-launching of the one or more identified given applications comprises partially loading the one or more identified given software applications as background applications executing in a minimized background processing state on an active desktop executing on the programmable integrated circuit, the one or more identified given software applications being hidden from the system user and not accepting input from the system user while executing in the minimized background processing state; and where the responding to the call from the system user for the at least one identified given application comprises completing the load of the at least one identified given application as a foreground application executing in a full foreground processing state that is visible to the system user and that accepts input from the system user on the active desktop on the programmable integrated circuit.

10. An information handling system, comprising:
at least one programmable integrated circuit; and
non-volatile memory coupled to the programmable integrated circuit;
where the at least one programmable integrated circuit is programmed to:
execute an operating system (OS) and one or more foreground applications,
collect input data from operation characteristics of the information handling system,
determining if the collected input data indicates an upcoming need for one or more identified given applications that are not currently called for by a system user of the information handling system and that are not executing on the at least one programmable integrated circuit of the information handling system;
then pre-launch the one or more identified given applications as background applications executing on the at least one programmable integrated circuit before the identified given applications are called for by the system user only if the collected input data indicates an upcoming need for the one or more identified given applications, the presence of the one or more pre-launched background applications being hidden from the system user and not accepting input from the system user; and
then respond to a call from the system user for at least one of the one or more identified given applications by transferring the identified given application to be a foreground application executing on the at least one programmable integrated circuit that is visible to the system user and that accepts input from the system user.

11. The information handling system of claim 10, where the at least one programmable integrated circuit is further programmed to:
collect current resource usage data from operation characteristics of the information handling system while the one or more identified given applications are executing as pre-launched background applications on the at least one programmable integrated circuit;
determining if the collected current resource usage data exceeds one or more predefined corresponding resource utilization threshold values; and
then terminate execution of at least one of the executing pre-launched background applications only if the collected current resource usage data exceeds the one or more predefined corresponding resource utilization threshold values to reduce the current usage of the one or more system resources so that the current usage of the one or more system resources no longer exceeds the one or more corresponding predefined resource utilization threshold values.

12. The information handling system of claim 10, where the at least one programmable integrated circuit is further programmed to:
pre-launch multiple identified given applications as multiple respective pre-launched background applications executing on the at least one programmable integrated circuit before the multiple identified given applications are called for by the system user only if the collected input data indicates an upcoming need for the multiple identified given applications, the presence of the multiple pre-launched background applications being hidden from the system user and not accepting input from the system user;
collect current resource usage data from operation characteristics of the information handling system while the multiple identified given applications are executing as multiple respective pre-launched background applications on the at least one programmable integrated circuit;
determine if the collected current resource usage data exceeds one or more predefined corresponding resource utilization threshold values; and
then select and terminate execution of only a first portion of the executing multiple pre-launched background applications only if the collected current resource usage data exceeds the one or more predefined corresponding resource utilization threshold values to reduce the current usage of the one or more system resources so that the current usage of the one or more system resources no longer exceeds the one or more corresponding predefined resource utilization threshold values while not terminating a remaining second portion of the executing multiple pre-launched background applications.

13. The information handling system of claim 12, where the at least one programmable integrated circuit is further programmed to select and terminate the execution of only a first portion of the executing multiple pre-launched background applications by selecting and terminating the first portion of the executing multiple pre-launched background applications according to a defined termination policy that includes at least one of terminating an executing pre-launched background application having a lower defined priority ranking before terminating one or more other executing pre-launched background application/s having a higher defined priority ranking, terminating an executing pre-launched background application that was pre-launched before one or more other executing pre-launched background application/s that were pre-launched later according to a first in-first out (FIFO) policy, or terminating an executing pre-launched background application first that exhibits the largest resource usage characteristics relative to other executing pre-launched background application/s.

14. The information handling system of claim 13, where the defined termination policy is stored on the non-volatile memory; and where the at least one programmable integrated circuit is further programmed to retrieve the defined termination policy from the non-volatile memory.

15. The information handling system of claim 10, where the at least one programmable integrated circuit is further programmed to:
collect the input data from operation characteristics of the information handling system by collecting the data from the executing foreground applications and/or other processes executing on the at least one programmable integrated circuit that are designated by a defined pre-launch policy as being indicative of system user behavior that is predictive of upcoming user need for one or more given application/s; and
determine if the collected input data indicates an upcoming need for one or more identified given applications by applying pre-defined criteria of the defined pre-launch policy to the collected input data to determine if the collected data from the executing foreground applications and/or other processes executing on the at least one programmable integrated circuit indicates an upcoming need for one or more identified given applications.

16. The information handling system of claim 15, where the defined pre-launch policy is stored on the non-volatile memory; and where the at least one programmable integrated circuit is further programmed to retrieve the defined pre-launch policy from the non-volatile memory.

17. The information handling system of claim 10, where the at least one programmable integrated circuit is further programmed to pre-launch the one or more identified given applications as background applications executing on the programmable integrated circuit by determining a time to pre-launch the one or more identified given applications based on a defined pre-launch policy.

18. The information handling system of claim 10, where the at least one programmable integrated circuit is further programmed to:
simultaneously execute an active primary desktop and an inactive virtual desktop;
pre-launch the one or more identified given applications by pre-launching the one or more software applications as background applications within the inactive virtual desktop that are hidden from the system user and that do not accept input from the system user; and
respond to the call from the system user for the at least one identified given application by transferring the at least one given application from the inactive virtual desktop to be a foreground application within the active primary desktop where it is visible to the system user and accepts input from the system user.

19. The information handling system of claim 10, where the at least one programmable integrated circuit is further programmed to:
simultaneously execute a first active primary desktop and an inactive virtual desktop;
pre-launch the one or more identified given applications by pre-launching the one or more software applications as background applications within the inactive virtual desktop that are hidden from the system user and that do not accept input from the system user; and
respond to the call from the system user for the at least one identified given application by transferring the inactive virtual desktop to be a second active primary desktop that includes the at least one identified given application executing as a foreground application that is visible to the system user and that accepts input from the system user within the second active primary desktop.

20. The information handling system of claim 10, where the at least one programmable integrated circuit is further programmed to:
pre-launch the one or more identified given applications by partially loading the one or more identified given software applications as background applications executing in a minimized background processing state on an active desktop executing on the programmable integrated circuit, the one or more identified given software applications being hidden from the system user and not accepting input from the system user while executing in the minimized background processing state; and
respond to the call from the system user for the at least one identified given application by completing the load of the at least one identified given application as a foreground application executing in a full foreground processing state that is visible to the system user and that accepts input from the system user on the active desktop on the programmable integrated circuit.
